(19) United States
(12) Patent Application Publication
(10) Pub. No.: US 2020/0249115 A1
(43) Pub. Date: Aug. 6, 2020

(54) FUEL LINE LEAK DETECTION SYSTEM AND METHOD

(71) Applicant: Sunwest Engineering Constructors, Inc., Chino, CA (US)

(72) Inventor: Spencer L. Kissick, Chino, CA (US)

(21) Appl. No.: 16/267,677

(22) Filed: Feb. 5, 2019

(51) Int. Cl. G01M 3/28; F02D 41/22

(52) U.S. Cl. CPC G01M 3/2815; F02D 2041/225; F02D 41/22

(57) ABSTRACT

A method for detection of a fuel line leak in a fuel system that includes a fuel reservoir, a generator and a fuel line. The method includes providing a pressure vessel. The method further includes connecting a test valve to the fuel line. The valve has a test position and a non-test position. In the test position the valve allows fluid communication between the fuel line and the pressure vessel, and in the non-test position the valve does not allow passage. The method includes monitoring a status of the generator and detecting the status of the generator to be idle. The method includes moving the valve to the test position and moving the valve to the non-test position upon detection of the status of the generator to be active. The method includes pressurizing the pressure vessel and the fuel line. The method includes measuring the pressure in the pressure vessel.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates in general to a fuel line leak detection system, and more particularly, the system and method of a fuel line leak detection of a fuel line of a generator and associated fuel reservoir.

All tank systems containing fuel products are required by federal and state laws to be equipped with monitoring devices which control and/or alert when fuel leaks within the system occurs. Monitoring devices vary among tank systems. In large, multi-generator installations, as is commonly found in hospitals or computer data centers, the fuel system is controlled by a programmable logic controller (PLC). Examples of such generators may be electrical generators used to generate electricity, boilers used to generate heat, and other similar equipment with a useful output. The PLC manages the flow of fuel, handles demand calls from installed pump and day tank equipment, provides safeguards, provides lead/lag, redundancy and control of myriad of processes based upon specific conditions being satisfied.

Standard fuel line leak detection equipment currently on the market is best suited for retail or commercial fueling facilities, such as gas stations and depends upon a “hook signal/demand call/pump-run signal” to activate and perform a leak detection test as is required. Generator systems are not typically conducive to integration with contemporary fuel line leak detection systems as such generator system lack equipment (e.g., dispenser nozzles) which typically trigger the detection processes of the line leak detection systems.

In view of the foregoing, there is a need in the art for an improved fuel line leak detection system and method of fuel line leak detection.

### BRIEF SUMMARY

According to an aspect of the invention, there is provided a method for detection of a fuel line leak in a fuel system. The fuel system includes a fuel reservoir, a generator configured to consume fuel to generate an output, and a fuel line in fluid communication with and between the fuel reservoir and the generator for transporting fuel from the fuel reservoir to the generator. The method includes providing a pressure vessel. The method further includes connecting in fluid communication a fuel pump to the pressure vessel. The method further includes connecting in fluid communication a pressure sensor to the pressure vessel. The method further includes connecting a test valve to the fuel line. The test valve has a test position and a non-test position. In the test position, the test valve allows fluid communication between the fuel line and the pressure vessel, and in the non-test position the test valve does not allow passage of fluid between the fuel line and the pressure vessel. The method further includes monitoring a status of the generator as being active or idle. The method further includes detecting the status of the generator to be idle. The method further includes moving the test valve to the test position while continuing to monitor the status of the generator and moving the test valve to the non-test position upon detection of the status of the generator to be active. In this regard, the method facilitates pressure testing for a line leak detection of the fuel line in a manner that does not interfere with the operation of the generator (and the overall fuel system 10) or any fuel monitoring safety devices associated with the fuel system 10. The method further includes pressurizing the pressure vessel and the fuel line using the fuel pump. The method further includes measuring the fluid pressure in the pressure vessel using the pressure sensor.

According to various embodiments of the invention, the fuel system may include a programmable logic controller (PLC) configured to control activation of the generator, and the monitoring of the status of the generator may include receiving an electrical signal from the PLC. The PLC may include a relay used in the activation of the generator, and the monitoring of the status of the generator includes receiving an electrical signal from the relay. The method may further include providing a test controller. The test controller is disposed in electrical communication with the fuel system, and in particular the PLC, for receiving an electrical signal indicative of the status of the generator being active. The pressuring of the pressure vessel may include allowing the pressure in the fuel line and the pressure vessel to equalize. The test valve may be a solenoid valve. The method may include connecting a first check valve in fluid communication with the pressure vessel. The first check valve may be in fluid communication with the fuel reservoir. The method may include connecting a second check valve in fluid communication with the pressure vessel. The second check valve may have an actuation pressure setting higher than an actuation pressure setting of the first check valve. The second check valve may be in fluid communication with the fuel reservoir.

According to another embodiment of the invention, there is provided a fuel line leak detection system for use with a fuel system. The fuel system includes a fuel reservoir, a generator configured to consume fuel to generate an output, and a fuel line in fluid communication with and between the fuel reservoir and the generator for transporting fuel from the fuel reservoir to the generator. The fuel line leak detection system includes a pressure vessel. The fuel line leak detection system further includes a fuel pump in fluid communication with the pressure vessel. The fuel line leak detection system further includes a pressure sensor in fluid communication with the pressure vessel and configured to sense pressure in the pressure vessel. The fuel line leak detection system further includes a test valve connectable to the fuel line. The test valve has a test position and a non-test position. In the test position the test valve allows fluid communication between the fuel line and the pressure vessel. In the non-test position the test valve does not allow passage of fluid between the fuel line and the pressure vessel. The fuel line leak detection system further includes a test controller disposable in electrical communication with the fuel system for receiving an electrical signal indicative of a status of the generator being active or idle. The test controller disposed in electrical communication with the test valve and configured to control the test valve to be in the test and non-test positions based upon the received electrical signal being indicative of the status of the generator being active or idle. The test controller is disposed in electrical communication with the pressure sensor for monitoring sensed pressure by the pressure sensor.

According to various embodiments of the invention, the test valve may be a solenoid valve. The system may further include a first check valve in fluid communication with the pressure vessel. The first check valve may be connectable in fluid communication with the fuel reservoir. The fuel line leak detection system may further include a second check valve in fluid communication with the pressure vessel. The second check valve has an actuation pressure setting higher than an actuation pressure setting of the first check valve. The second check valve may be connectable in fluid communication with the fuel reservoir.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a symbolic diagram illustrating a fuel system and a fuel line leak detection system according to an aspect of the invention; and

FIG. 2 is a flow diagram of a method of fuel line leak detection according to another embodiment of the invention.

### DETAILED DESCRIPTION

The detailed description set forth below in connection with the appended drawings is intended as a description of certain embodiments of a fuel line leak detection system and related method of fuel line leak detection, and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

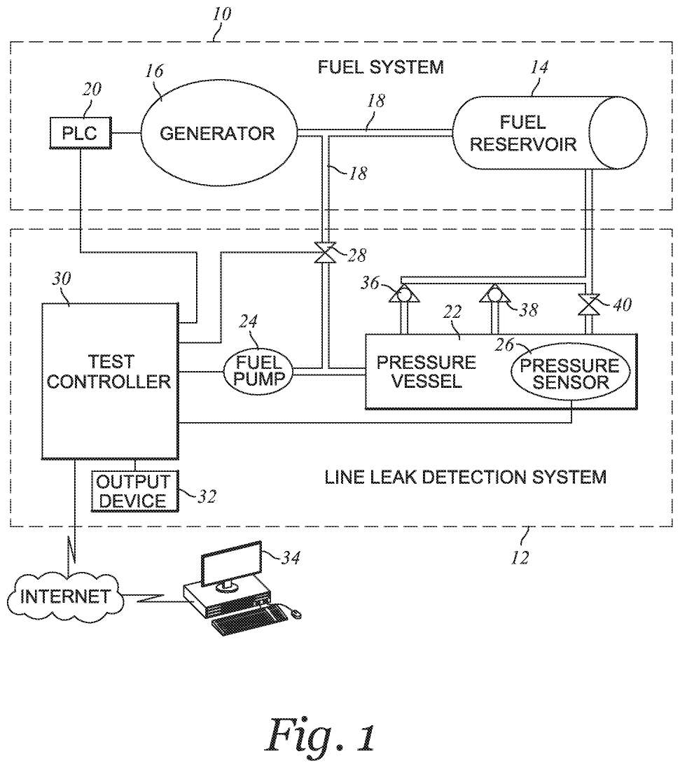

Referring now to FIG. 1 there is depicted a symbolic diagram illustrating a fuel system 10 and a fuel line leak detection system 12 according to an aspect of the invention. The fuel system 10 includes a fuel reservoir 14. The fuel reservoir 14 may be any form of a fuel storage container/tank and may take the form of tanks which may be installed in-ground or above-ground. Further the term fuel reservoir 14 may refer to one or more items, such as an in-ground tank and a connected above-ground day tank.

The fuel system 10 further includes a generator 16 configured to consume fuel to generate an output. Such fuel may include any liquid or gaseous fuel, such as gasoline and other petroleum products and even natural gases. The generator 16 may take the form of an electrical generator configured to generate electricity or a boiler configured to generate heat or other similar equipment. Such generator 16 may only be used intermittently, such as for emergency or back-up purposes. The fuel system 10 further includes a fuel line 18 in fluid communication with and between the fuel reservoir 14 and the generator 16 for transporting fuel from the fuel reservoir 14 to the generator 16. As used herein the term fuel line 18 refers to a fluid supply line, piping or conduit, which may include one or more interconnected segments. It is contemplated that the fuel reservoir 14 may be elevated in comparison to the generator 16 so as to provide a pressure head to allow for the delivery of fuel through the fuel line 18. It is also contemplated that various forms of pumping mechanisms may also be utilized, such as fluid pumps located at any point within the fuel system 10.

The generator 16 may be utilized such as an emergency generator or back-up power source. In this regard, the generator 16, and the fuel system 10, may typically have an idle status and periodically or intermittently have an active status. In this regard, the fuel system 10 may include a programmable logic controller (PLC) 20 configured to control activation of the generator 16.

According to another embodiment of the invention, there is provided the fuel line leak detection system 12 for use with the fuel system 10. The fuel line leak detection system 12 includes a pressure vessel 22. The pressure vessel 22 may take the form of a manifold that may be configured to receive various pressure line inputs and outputs. While in the embodiment depicted, the fuel system 10 features a single generator 16 and single fuel reservoir 18, it is contemplated that there may be an array of generators or boilers, for example, and more than one fuel reservoir, as may be the case in a large scale emergency system. In this regard, the pressure vessel 22 may be configured to receive inputs from a variety of fuel lines in addition to the fuel line 18 directly connecting the generator 16 and the fuel reservoir 14.

The fuel line leak detection system 12 further includes a fuel pump 24 in fluid communication with the pressure vessel 22. In this regard, the fuel pump 24 is external to the fuel system 10. The fuel pump 24 may take the form of a positive displacement pump that is configured to pressurize the attached fuel lines. In the embodiment depicted, the fuel pump 24 is attached via a supply line to the pressure vessel 22. However, the fuel pump 24 may be disposed in fluid communication though any number of intermediate supply lines and conduits in alternative configurations as well.

The fuel line leak detection system 12 further includes a pressure sensor 26 in fluid communication with the pressure vessel 22 and configured to sense pressure in the pressure vessel 22. The pressure sensor 26 may take the form of a pressure transducer which may produce a digital signal indicative of the sensed pressure. The pressure sensor 26 may additionally have a digital or analog readout for direct visual observation.

The fuel line leak detection system 12 further includes a test valve 28 connectable to the fuel line. The test valve 28 has a test position and a non-test position. In the test position the test valve 28 allows fluid communication between the fuel line 18 and the pressure vessel 22. In the non-test position the test valve 28 does not allow passage of fluid between the fuel line 18 and the pressure vessel 22. The test valve 28 may be an electromechanical device, such as a solenoid valve. In the embodiment depicted, the test valve 28 is attached via a supply line to the pressure vessel 22 and a supply line to the fuel line 18. However, the test valve 28 may be disposed in fluid communication though any number of intermediate supply lines and conduits in alternative configurations as well.

The fuel line leak detection system 12 further includes a test controller 30 disposable in electrical communication with the fuel system 10 for receiving an electrical signal indicative of a status of the generator 16 being active or idle. The test controller 30 disposed in electrical communication with the test valve 28 and configured to control the test valve to be in the test and non-test positions based upon the received electrical signal being indicative of the status of the generator 16 being active or idle. The test controller 30 is disposed in electrical communication with the pressure sensor 26 for monitoring sensed pressure by the pressure sensor 26.

It is contemplated that the pressure vessel 22, the fuel pump 24, the pressure sensor 26, the test valve 28 and test controller 30 may be installed, configured and chosen from any of those techniques and products which are well known to one of ordinary skill in the art.

An output device 32 may be connected to the test controller 30. The output device 32 may be used to display any of the information sent to the test controller 30 (such as sensed pressure values from the pressure sensor 26, the status of the generator 16, timing information and any other information concerning the operation of the test controller 30) the output device 32 may also be an input device to as to allow the user to interact with the test controller 30.

It is contemplated that the test controller 30 may be remotely controlled, monitored and/or activated. The test controller 30 may be connected to an external computer network, such as the Internet, which then may be interacted with via a remote computer 34.

As mentioned above, the test controller 30 is configured to receive an electrical signal indicative of a status of the generator 16 being active or idle. In this regard, the test controller 30 may be electrically connected to the PLC 20 of the fuel system 10. The PLC 20 may include a non-contact relay that is electrically disposed between the generator 16 and those portions of the PLC that control activation of the generator 16. It is understood that a particular placement of the non-contact relay may not be physically part of the PLC 20 itself, but rather connected thereto. The test controller 30 may be connected to the relay to receive an electrical signal indicative of a status of the generator as being active or idle. In a PLC 20/generator 16 configuration where an electrical signal passing through the relay upon where the relay is closed, this would indicate that power is flowing to the generator 16 to activate the generator 16. Where the test controller detects such an event, the test controller 30 is configured to recognize that this is indicative of the generator 16 having an active status. Where the test controller 30 does not receive any electrical signals flowing through the relay, this would be indicative of the generator 30 having an idle status.

It is contemplated that the test controller 30 is connected to the fuel system 10 in a manner that does not interfere with the operation of the generator 16 (and the overall fuel system 10) or any fuel monitoring safety devices. The connection to the relay may be viewed as being minimally invasive to help insure that connecting the fuel leak detection system 12 does not have any impact on the operation of the operation of the generator 16 and the overall fuel system 10 or any connected fuel monitoring safety devices. However, it is contemplated that the test controller 30 may receive a direct output from the PLC 20 or the generator 16 itself to the extent that such components have such output connections, which out vary based upon the particular of such components.

The fuel line leak detection system 12 may further include a first check valve 36 in fluid communication with the pressure vessel 22. The first check valve may have an actual pressure setting configured to open and allow fluid flow through the first check valve 36 at a pre-determined pressure, such as 25 psi for example. The first check valve 36 may be connectable in fluid communication with the fuel reservoir 14. In this regard, should the first check valve 36 ever be activated to allow passage of fuel therethrough, the passed fuel would be contained and recycled back to the fuel reservoir 14. It is understood that fuel having pressure below the pre-determined set pressure of the first check valve would remain in pressure vessel 22 and connected supply lines. This provides a means for the fuel line leak detection system 12 to hold pressure on the connected fuel line 18 for pressure testing.

The fuel line leak detection system 12 may further include a second check valve 38 in fluid communication with the pressure vessel 22. The second check valve 38 has an actuation pressure setting higher than an actuation pressure setting of the first check valve 36. For example, the second check valve 38 may have an actuation pressure setting of 50 psi. The second check valve 38 may be used as an emergency relief valve, for safely removing any unexpected excessive pressure from the system. The second check valve 38 may be connectable in fluid communication with the fuel reservoir 14. In this regard, should the second check valve 38 ever be activated to allow passage of fuel therethrough, the passed fuel would be contained and recycled back to the fuel reservoir 14.

The fuel line leak detection system may 12 further include an air bleed valve 40, such as in the form of a solenoid valve, that may be used to remove any unwanted air from the supply lines recirculating fuel from the first and second check valve to the fuel reservoir 14.

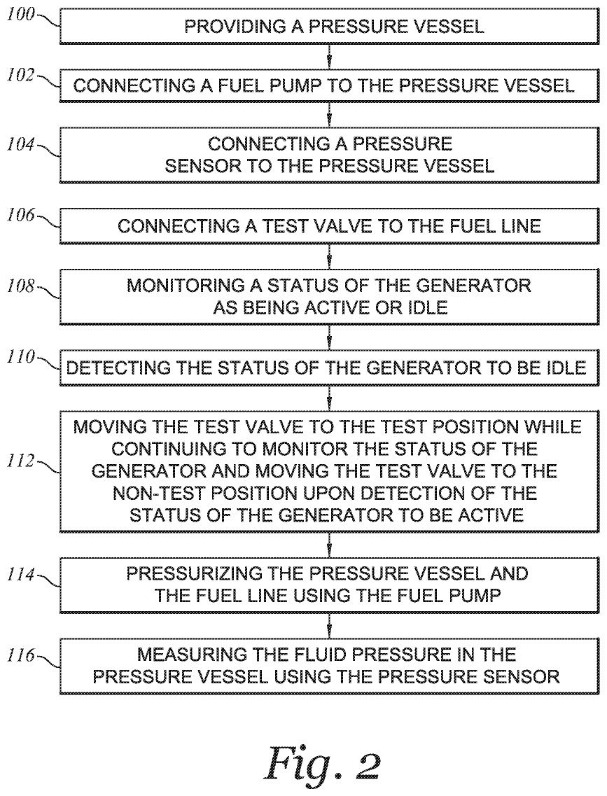

FIG. 2 is a flow diagram of a method of a fuel line leak detection according to another embodiment of the invention. The method initially includes the step 100 of providing the pressure vessel 22. The method further includes the step 102 of connecting in fluid communication the fuel pump 24 to the pressure vessel 22. The method further includes the step 104 of connecting in fluid communication the pressure sensor 26 to the pressure vessel 22. The method further includes the step 106 of connecting the test valve 28 to the fuel line 18. As described above, the test valve 28 has a test position and a non-test position. The method further includes the step 108 of monitoring a status of the generator 16 as being active or idle. The method further includes the step 110 of detecting the status of the generator 16 to be idle. The method further includes the step 112 of moving the test valve 28 to the test position while continuing to monitor the status of the generator 16 and moving the test valve 28 to the non-test position upon detection of the status of the generator 16 to be active.

The method further includes the step 114 of pressurizing the pressure vessel 22 and the fuel line 18 using the fuel pump 24. This may include drawing fuel from a source in the fuel system 10, such as the fuel reservoir, to initially push fuel into the pressure vessel 22. The step 114 of pressuring of the pressure vessel 22 may include allowing the pressure in the fuel line 18 and the pressure vessel 22 to equalize. This may include allowing the pressure in the fuel line 18 to be reduced or increased as may be the case. The method further includes the step 116 measuring the fluid pressure in the pressure vessel 22 using the pressure sensor 26. As will be recognized to those skilled in the art, the measured fluid pressure readings will be used to determine whether there are any leaks within the fuel line 18. The test controller 30, which may be referred to as a monitoring panel, may be used to perform any required tests and protocols of the manufacturer of the test controller 30 and/or in relation to applicable regulations, such as having the pressure in the fuel line 18 pressurized by the fuel pump 24 to a specific set pressure or pressures at various intervals of time and measured at various specified times.

At any point during the step 114 of pressuring the pressure vessel 22 the status of the generator 16 is detected to be active, the method provides that the test valve 28 will be automatically triggered to be closed. This allows the fuel system 10 to function without interference by the line leak detection system 12.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method for detection of a fuel line leak in a fuel system, the fuel system including a fuel reservoir, a generator configured to consume fuel to generate an output, and a fuel line in fluid communication with and between the fuel reservoir and the generator for transporting fuel from the fuel reservoir to the generator, the method comprising:
(a) providing a pressure vessel;
(b) connecting in fluid communication a fuel pump to the pressure vessel;
(c) connecting in fluid communication a pressure sensor to the pressure vessel;
(d) connecting a test valve to the fuel line, the test valve having a test position and a non-test position, in the test position the test valve allowing fluid communication between the fuel line and the pressure vessel, in the non-test position the test valve not allowing passage of fluid between the fuel line and the pressure vessel;
(e) monitoring a status of the generator as being active or idle;
(f) detecting the status of the generator to be idle;
(g) moving the test valve to the test position while continuing to monitor the status of the generator and moving the test valve to the non-test position upon detection of the status of the generator to be active;
(h) pressurizing the pressure vessel and the fuel line using the fuel pump; and
(i) measuring the fluid pressure in the pressure vessel using the pressure sensor.

2. The method of claim 1 wherein the fuel system includes a programmable logic controller (PLC) configured to control activation of the generator, the monitoring of the status of the generator includes receiving an electrical signal from the PLC.

3. The method of claim 2 wherein the PLC includes a relay used in the activation of the generator, the monitoring of the status of the generator includes receiving an electrical signal from the relay.

4. The method of claim 2 further includes providing a test controller, the test controller is disposed in electrical communication with the PLC for receiving an electrical signal indicative of the status of the generator being active.

5. The method of claim 1 further includes providing a test controller, the test controller is disposed in electrical communication with the fuel system for receiving an electrical signal indicative of the status of the generator being active, the test controller is disposed in electrical communication with the test valve and configured to control the test valve to be in the test and non-test positions, the test controller is disposed in electrical communication with the pressure sensor for monitoring sensed pressure by the pressure sensor.

6. The method of claim 1 wherein the pressuring of the pressure vessel includes allowing the pressure in the fuel line and the pressure vessel to equalize.

7. The method of claim 1 wherein the test valve is a solenoid valve.

8. The method of claim 1 further includes connecting a first check valve in fluid communication with the pressure vessel.

9. The method of claim 8 wherein the first check valve is in fluid communication with the fuel reservoir.

10. The method of claim 8 further includes connecting a second check valve in fluid communication with the pressure vessel, the second check valve has an actuation pressure setting higher than an actuation pressure setting of the first check valve.

11. The method of claim 10 wherein the second check valve is in fluid communication with the fuel reservoir.

12. A fuel line leak detection system for use with a fuel system, the fuel system including a fuel reservoir, a generator configured to consume fuel to generate an output, and a fuel line in fluid communication with and between the fuel reservoir and the generator for transporting fuel from the fuel reservoir to the generator, the fuel line leak detection system comprising:
a pressure vessel;
a fuel pump in fluid communication with the pressure vessel;
a pressure sensor in fluid communication with the pressure vessel and configured to sense pressure in the pressure vessel;
a test valve connectable to the fuel line, the test valve having an test position and a non-test position, in the test position the test valve allowing fluid communication between the fuel line and the pressure vessel, in the non-test position the test valve not allowing passage of fluid between the fuel line and the pressure vessel; and
a test controller disposable in electrical communication with the fuel system for receiving an electrical signal indicative of a status of the generator being active or idle, the test controller disposed in electrical communication with the test valve and configured to control the test valve to be in the test and non-test positions based upon the received electrical signal being indicative of the status of the generator being active or idle, the test controller disposed in electrical communication with the pressure sensor for monitoring sensed pressure by the pressure sensor.

13. The fuel line leak detection system of claim 12 wherein the test valve is a solenoid valve.

14. The fuel line leak detection system of claim 12 further includes a first check valve in fluid communication with the pressure vessel.

15. The fuel line leak detection system of claim 14 wherein the first check valve is connectable in fluid communication with the fuel reservoir.

16. The fuel line leak detection system of claim 14 further includes a second check valve in fluid communication with the pressure vessel, the second check valve has an actuation pressure setting higher than an actuation pressure setting of the first check valve.

17. The fuel line leak detection system of claim 16 wherein the second check valve is connectable in fluid communication with the fuel reservoir.
